(19) United States
(12) Patent Application Publication
(10) Pub. No.: US 2006/0119763 A1
(43) Pub. Date: Jun. 8, 2006

(54) Backlight assembly and liquid crystal display device having the same

(75) Inventors: Heu-Gon Kim, Suwon-si (KR); Sang-Hyuck Yoon, Seoul (KR); Jae-Ho Jung, Yongin-si (KR); Hea-Chun Lee, Suwon-si (KR)

Correspondence Address: MCGUIREWOODS, LLP, 1750 TYSONS BLVD, SUITE 1800, MCLEAN, VA, 22102, US

(73) Assignee: Samsung Electronics Co., Ltd.

(21) Appl. No.: 11/239,337

(22) Filed: Sep. 30, 2005

(30) Foreign Application Priority Data
Oct. 8, 2004 (KR) 10-2004-0080403

(51) Int. Cl. G02F 1/1335

(52) U.S. Cl. 349/70

(57) ABSTRACT

A flat fluorescent lamp is provided that includes a body including a first substrate, a second substrate opposite to the first substrate and comprising a light emitter, a space divider, and a discharging space between the first substrate and the second substrate, wherein the light emitter has an embossed surface.

### CROSS REFERENCE TO RELATED APPLICATION

This application claims priority to and the benefit of Korean Patent Application No. 10-2004-0080403, filed on Oct. 8, 2004, which is hereby incorporated by reference for all purposes as if fully set forth herein.

### BACKGROUND OF THE INVENTION

1. Field of the Invention

The present invention relates to a backlight assembly and a liquid crystal display device having the same.

2. Description of Related Art

Various types of display devices are used for computers, television sets, etc., including self-emitting displays such as light emitting diodes (LEDs), electroluminescence devices (ELs), vacuum fluorescent displays (VFDs), field emission displays (FEDs) and plasma panel displays (PDPs), and non-emitting displays, such as liquid crystal displays (LCDs). The non-emitting displays require a light source and the self-emitting displays do not.

An LCD includes two panels with field-generating electrodes and a liquid crystal (LC) layer with dielectric anisotropy interposed therebetween. The field-generating electrodes generate an electric field in the liquid crystal layer in response to applied voltages. The transmittance of light passing through the panels varies depending on the strength of the electric field, which is controlled by the applied voltages. Accordingly, desired images are displayed by adjusting the applied voltages.

The light source for an LCD may be an artificial light source that is installed in the LCD device, or natural light. When using the artificial light source, the brightness of the LCD screen is adjusted by either regulating the ratio of “on” and “off” durations of the light source or regulating current through the light source.

The artificial light source, which is part of a backlight assembly, is often implemented via a plurality of fluorescent lamps, such as cold cathode fluorescent lamps (CCFLs), that are connected to a plurality of inverters for driving the lamps. The lamps may be disposed under an LC panel assembly, such as in a direct-type backlight assembly, or may be disposed along one or more edges of the LC panel assembly, such as in an edge-type backlight assembly.

The direct-type backlight assembly or the direct-type backlight assembly include optical members, such as a light guide or a diffusing plate that causes a light loss, and thereby efficiency of the light decreases and the configuration of the backlight assembly is complicated which increases manufacturing costs and decreases the uniformity of luminance.

To solve some of the above described problems, a backlight assembly having a flat fluorescent lamp (FFL) is used. The FFL includes a body that is divided into a plurality of discharging spaces, and electrodes applying a discharge voltage to the light source body. Plasma discharging occurs into the divided spaces by applying the discharge voltage to the electrodes, and thereby the FFL emits light. However, a dark portion occurs between adjacent discharging spaces, which decreases the uniformity of luminance.

### SUMMARY OF THE INVENTION

The present invention solves the problems associated with conventional techniques for emitting light in a non-emitting display device. Additional features of the invention will be set forth in the description which follows, and in part will be apparent from the description, or may be learned by practice of the invention.

The present invention discloses a flat fluorescent lamp, including a body comprising a first substrate, a second substrate opposite to the first substrate and comprising a light emitter and a space divider, and a discharge space between the first substrate and the second substrate, wherein the light emitter has an embossed surface.

The present invention also discloses a flat fluorescent lamp, including a body comprising a first substrate, a second substrate positioned opposite to the first substrate and comprising a light emitter and a space divider, and a discharge space between the first substrate and the second substrate, wherein the first substrate has a projection.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an exploded perspective view of a backlight assembly according to an embodiment of the invention.

FIG. 2 is a sectional view of a backlight assembly shown in FIG. 1 taken along the line II-II.

FIG. 3 is a sectional view of a backlight assembly according to an embodiment of the invention.

FIG. 4 is a sectional view of a backlight assembly according to an embodiment of the invention.

FIG. 5A and FIG. 5B are graphics illustrating luminance distribution in accordance with an emitting position and conventional luminance distribution in accordance with an emitting angle.

FIGS. 6A and 6B are graphics illustrating luminance distribution in accordance with an emitting position and luminance distribution in accordance with an emitting angle according to an embodiment of the present invention.

FIG. 7 is a perspective view of a light source body shown in FIG. 1.

FIG. 8 is an enlarged diagram of the “E” portion of the light source body shown in FIG. 7.

FIG. 9 is a sectional view of the light source body shown in FIG. 8 taken along a line F-F.

FIG. 10 is an exploded perspective view of a liquid crystal display device according to an embodiment of the invention.

### DETAILED DESCRIPTION OF ILLUSTRATED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein.

In the drawings, the thickness of layers and regions are exaggerated for clarity. Like numerals refer to like elements throughout. It will be understood that when an element such as a layer, film, region, substrate, or panel is referred to as being “on” another element, it can be directly on the other element or intervening elements may also be present. In contrast, when an element is referred to as being “directly on” another element, no intervening elements are present.

Backlight assemblies and display devices having the backlight assembly according to embodiments of the invention are described below with reference to the drawings.

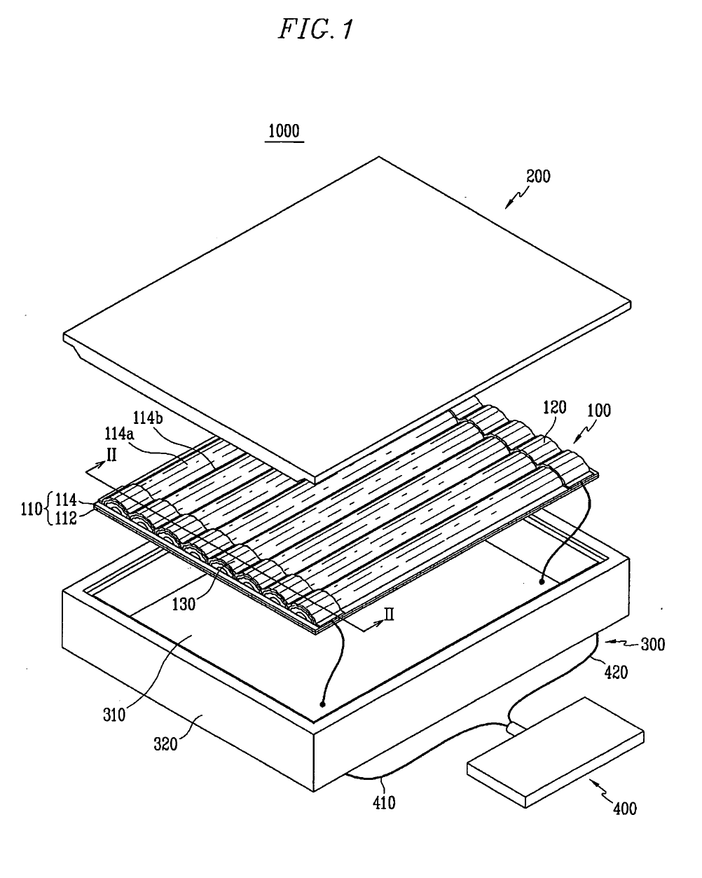

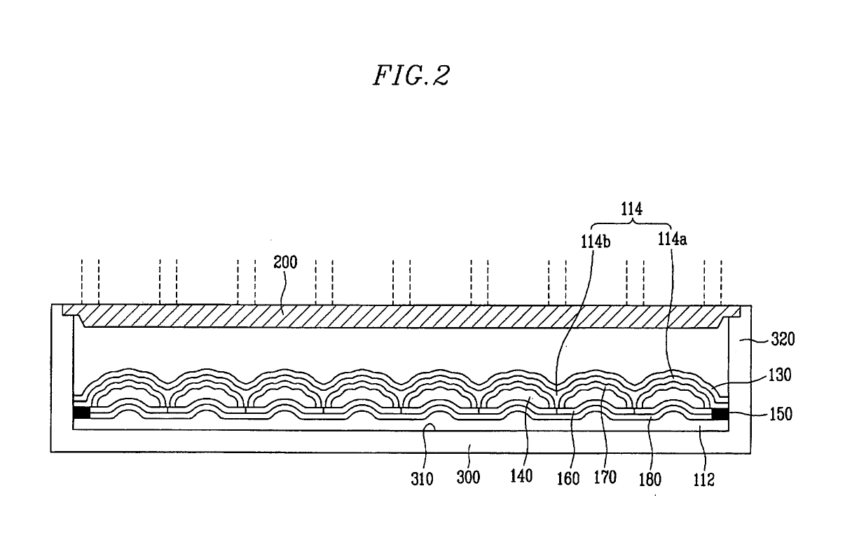

FIG. 1 is an exploded perspective view of a backlight assembly according to an embodiment of the invention. FIG. 2 is a sectional view of a backlight assembly shown in FIG. 1 taken along the line II-II.

Referring to FIG. 1 and FIG. 2, a backlight assembly may include a flat fluorescent lamp (FFL) 100, a diffusing plate 200, a container 300, and an inverter 400.

The FFL 100 includes a body 110 which is divided into a plurality of discharging spaces and a first electrode 120 and a second electrode 130 respectively formed on the ends of the body 110.

The body 110 includes a first substrate 112 and a second substrate 114 formed on the first substrate 112.

The first substrate 112 may have a rectangular shape and may be made of a transparent glass that allow light or visible rays to pass through but blocks ultraviolet rays. As shown in FIG. 2, the first substrate 112 includes one or more semi-circular projections formed or provided on the surface thereof.

The second substrate 114 forms an inner space along with the first substrate 112 and may be made of transparent glass. The second substrate 114 may include a plurality of light emitters 114a spaced along the first substrate 112 in the inner space, and a plurality of space dividers 114b dividing the inner space into a plurality of discharging spaces 140 adjacent to the first substrate 112. The space dividers 114b are arranged at predetermined intervals, e.g., constant intervals. The second substrate 114 may be formed as described above. After heating a base substrate e.g., the first substrate 112, at a predetermined temperature, the base substrate is formed using a desired metallic pattern to obtain the second substrate 114.

In an embodiment of the present invention, as shown in FIG. 2, the light emitters 114a of the second substrate 114 may be arranged sequentially and have a round-like shape, e.g., a semi-elliptical shape, with an embossed surface. Alternatively, the respective light emitters 114a may have a semi-circular or rectangular shape with an embossed surface.

The second substrate 114 and the first substrate 112 are combined via an adhesive member 150, such as melted PbO containing glass. The adhesive member 150 may be interposed between the second substrate 114 and the first substrate 112 to enclose edge portions of the second substrate 114 and the first substrate 112 and may be heated to combine the second substrate 114 with the first substrate 112.

Since the adhesive member 150 is only formed at the edge portions between the second substrate 114 and the first substrate 112, the space dividers 114b are positioned close to the first substrate 112 because of a pressure difference between inside and outside of the discharging space 114a. Each discharging space 140 is supplied with a discharge gas at about 500 torr. However, since atmospheric pressure is about 760 torr, the space dividers 114b are positioned close to the first substrate 112 because of the pressure difference between the discharge gate and the atmosphere, thereby forming the discharging spaces 140.

The first electrode 120 and the second electrode 130 are at opposite ends of an outer surface of the second substrate 114. The first electrode 120 and the second electrode 130 extend across the long axis of the space dividers, thereby crossing the discharging spaces 140.

The first electrode 120 and the second electrode 130 may be formed by a spray coating technique using metal powders having good conductive materials, for example, Cu, Ni, Ag, Au, Al, and Cr. Alternatively, the first electrode 120 and the second electrode 130 may be formed by attaching an Al tape or coating Ag paste thereto. The first electrode 120 and the second electrode 130 may be formed by dipping both ends of the body 110 into a melted conductive material.

The first electrode 120 and the second electrode 130 are formed on the outer surface of the second substrate 114, but may be formed on an outer surface of the first substrate 112 or on both the outer surface of the second substrate 114 and first substrate 112.

Meanwhile, the FFL 100 includes a first fluorescent layer 160 and a second fluorescent layer 170, and a reflective layer 180 formed between the first substrate 112 and the first fluorescent layer 160. The first fluorescent layer 160 is formed on the first substrate 112, and the second fluorescent layer 170 is formed in the second substrate 114. The first fluorescent layer 160 and the second fluorescent layer 170 are positioned opposite to each other and are excited by ultraviolet rays generated due to the plasma discharging to emit visible rays. The reflective layer 180 reflects the visible rays toward the second substrate 114 to prevent light leakage through the first substrate 112.

In addition, the FFL 100 may further include a protective layer (not shown). The protective layer may be formed between the second substrate 114 and the second fluorescent layer 170 or between the first substrate 112 and the reflective layer 180. The protective layer prevents the chemical reaction of Hg, which is the principal component of the discharge gas, with the first substrate 112 or second substrate 114, which reduces Hg loss.

The diffusing plate 200 is disposed on a top surface of the FFL 100 to diffuse light from the FFL 100.

Thus, by spacing the diffusing plate 200 at a predetermined distance from the FFL 100, a dark portion occurring near the space dividers 114b decreases, which increases the luminance uniformity of the FFL 100.

The luminance characteristic of the backlight assembly 1000 may vary depending on thickness of the diffusing plate 200, a distance between the diffusing plate 200 and the FFL 100, and etc.

The container 300 contains the FFL 100 and the diffusing plate 200, and includes a bottom 310 and a plurality of sidewalls 320 having a predetermined height. The sidewalls 320 are adjoined with the four sides of the FFL 100. A step-like ledge may be formed on a top end of each sidewall 320 to guide a containing position of the diffusing plate 200.

The inverter 400 may be disposed under the container 300 and generates a discharge voltage for driving the FFL 100. The discharge voltage from the inverter 400 is applied to the first electrodes 120 and the second electrodes 130 through the signal lines 410 and 420, respectively.

Meanwhile, the body 110 includes coupling passes that couple adjacent discharging spaces 140 together, so that the discharge gas may be uniformly distributed.

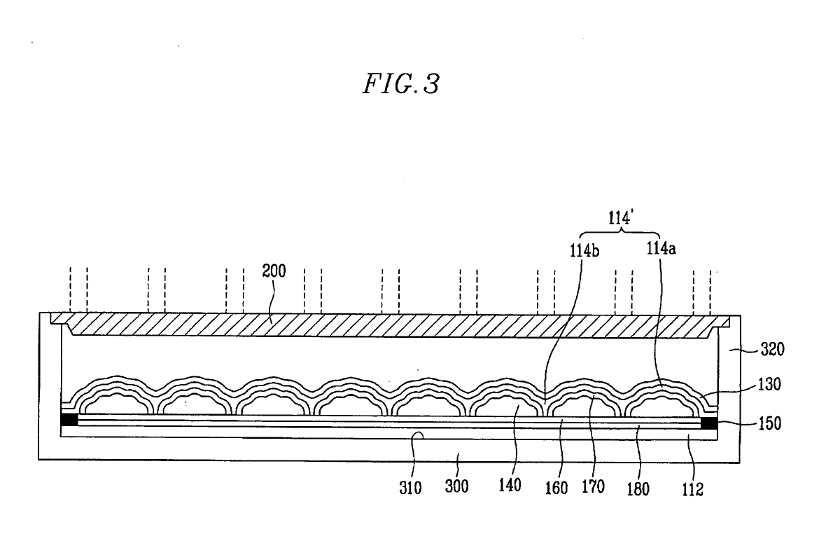

A backlight assembly according to another embodiment of the invention is described below with reference to FIG. 3.

Referring to FIG. 3, the structure of the backlight assembly may be substantially the same as the structure of the backlight assembly shown in FIG. 1 and FIG. 2, except for the second substrate 114′. Unlike in FIG. 2, the second substrate 114′ does not have an embossed surface. Instead, the second substrate 114′ has a smooth surface with a round-like shape, e.g., a semi-elliptical shape.

A backlight assembly according to another embodiment of the present invention is described below with reference to FIG. 4.

Referring to FIG. 4, the structure of the backlight assembly may be the same or substantially the same as the structure of the backlight assembly shown in FIG. 1 and FIG. 2, except for the first substrate 112′. Unlike in FIG. 2, the first substrate 112′ does not include projections.

The luminance distribution of the present invention in accordance with an emitting position and an emitting angle is compared below with the luminance distribution of a conventional art.

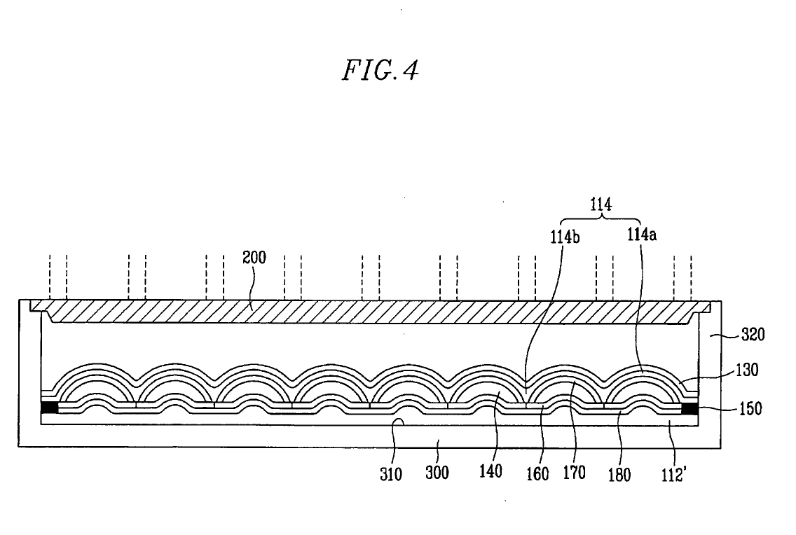

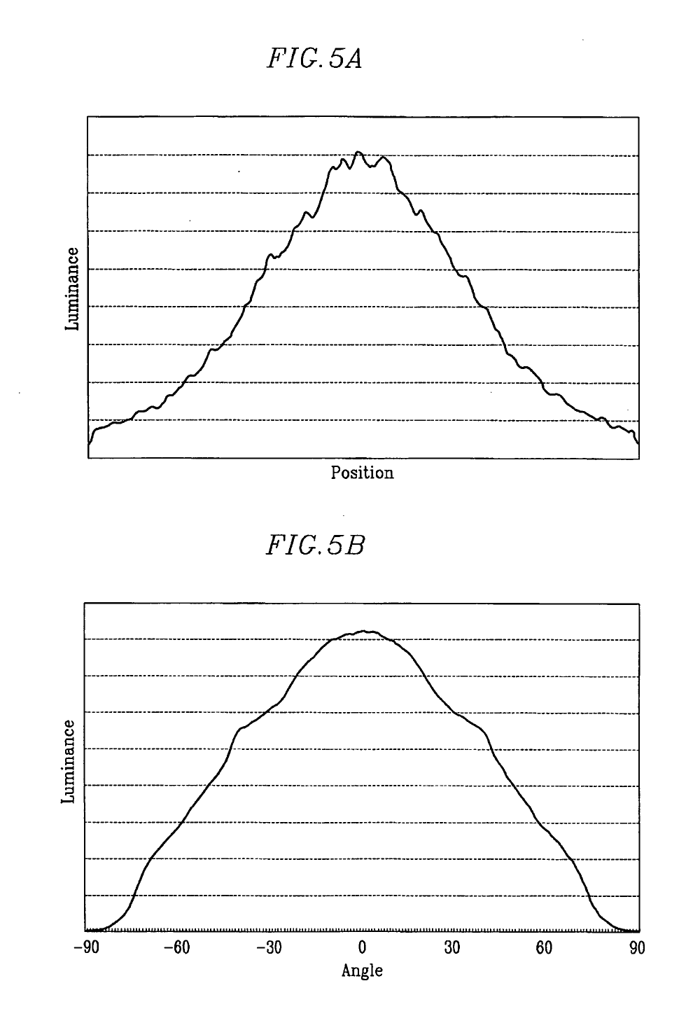

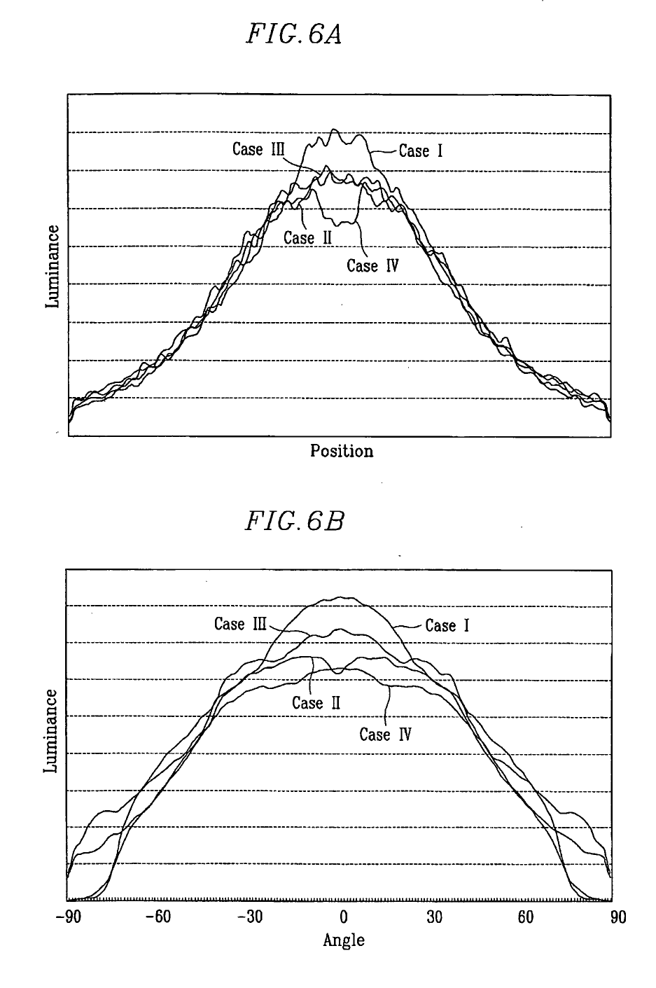

FIG. 5A and FIG. 5B are graphics illustrating luminance distribution in accordance with emitting positions and luminance distribution in accordance with emitting angles according to a conventional art, respectively. FIG. 6A and FIG. 6B are graphics illustrating luminance distribution in accordance with emitting positions and luminance distribution in accordance with emitting angles according to an embodiment of the invention, respectively.

In FIG. 6A and FIG. 6B, the cases I and I′ illustrate luminance distributions based on emitting position angles of light from the FFL 100 according to a conventional art.

The cases II and II′ illustrate luminance distributions based on emitting position angles of light from an FFL, which has the first substrate 112′ of the flat surface and the second substrate 114 of the embossed surface, shown in FIG. 4.

The cases III and III′ illustrate luminance distributions based on emitting position angles of light from the FFL 100, which has the first substrate 112 with the projections and the second substrate 114 of the smooth surface, shown in FIG. 3.

The cases IV and IV′ illustrate luminance distributions based on emitting position angles of light from the FFL 100, which has the first substrate 112 with the projections and the second substrate 114 of the embossed surface, shown in FIG. 2.

As shown in FIGS. 5A, 5B, 6A, and 6B, the luminance distributions in the cases II and II″, III and III′, and IV and IV′ are substantially uniform. However, the case I and I′ is not uniform. That is, light from sides is emitted by the embossed surface of the second substrate 114 or the projections of the first substrate 112 formed on portions corresponding to the light emitter 114a, and thereby the luminance distributions of light become uniform.

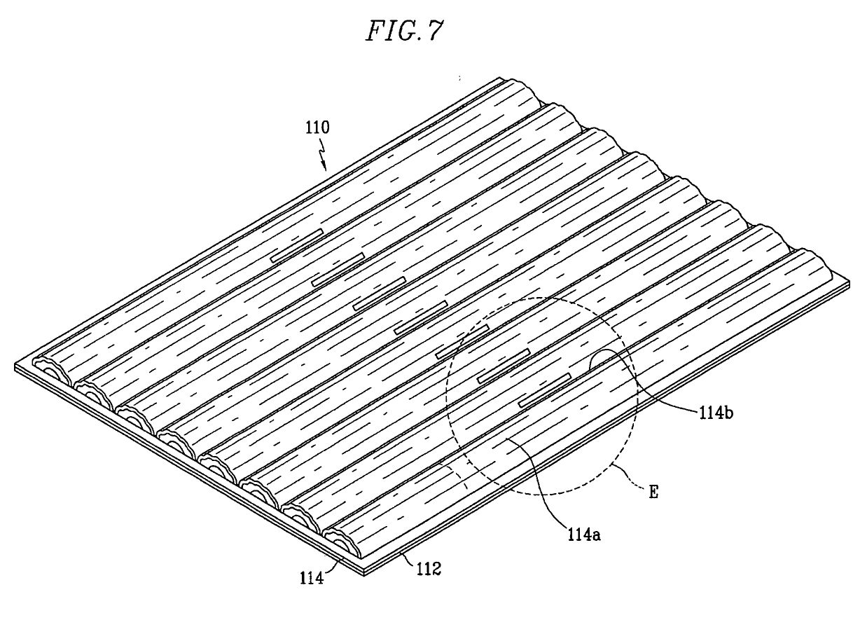

Next, the body 110 shown in FIG. 1 will be described in detail with reference to FIGS. 7, 8, and 9.

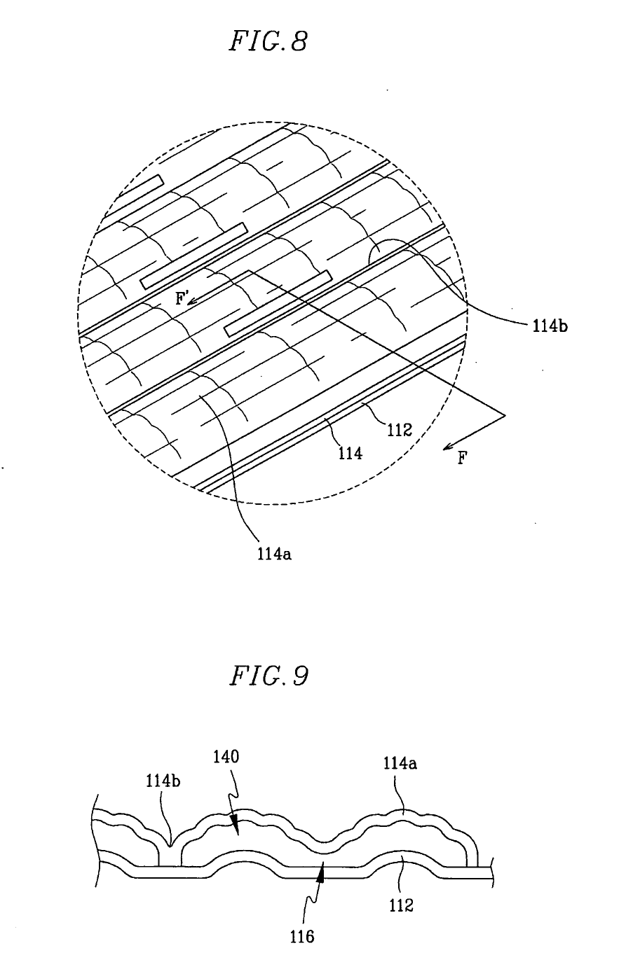

FIG. 7 is a perspective view of a light source body shown in FIG. 1. FIG. 8 is an enlarged diagram of the “E” portion of the light source body shown in FIG. 7. FIG. 9 is a sectional view of the light source body shown in FIG. 8 taken along a line F-F.

Referring to FIGS. 7, 8, and 9, the respective space dividers 114b of the second substrate 114 have at least one coupling pass 116 spaced over the first substrate 112. The coupling pass 116 may be formed at a center portion between adjacent space dividers 114b along a long axis thereof. The coupling pass 116 may be depressed less than the space dividers 114b when forming the second substrate.

A discharge gas applied to at least one discharging space 140 flows or travels into another discharging space 140 through the coupling pass 116 so that the discharge gas is uniformly distributed to all of the discharging spaces 140.

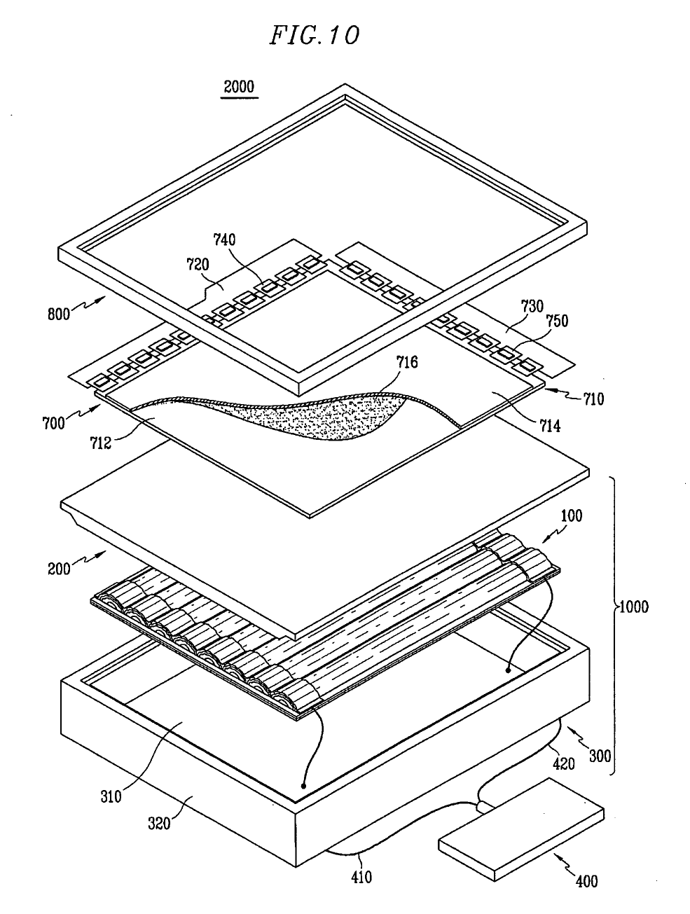

A liquid crystal display according to an embodiment of the invention is described below with reference to FIG. 10.

Referring to FIG. 10, a liquid crystal display (LCD) may include a backlight assembly 1000, a display unit 700, and a fixing member 800. The backlight assembly 1000 is the same or substantially equivalent to the backlight assembly described with reference to FIGS. 1 through 9, and the description of the backlight assembly 1000 is omitted for purposes of convenience.

The display unit 700 may include a liquid crystal (LC) panel 710 and a data printed circuit board (PCB) 720. PCBs 730 that supply driving signals to drive the LC panel 710. The driving signals supplied from the data PCB 720 and the gate PCBs 720 and 730 are applied to the LC panel 710 through data tape carrier packages (TCPs) 740 and gate TCPs 750.

The PC panel 710 may include a thin film transistor (TFT) panel 712, a color filter panel 714 facing the TFT panel 712, and an LC layer 716 interposed between the panels 712 and 714.

The TFT panel 712 may be made of a transparent glass on which switching is elements, such as TFTs (not shown), are formed in a matrix. Source and gate terminals of each TFT are connected to gate lines and data lines, respectively, and a drain terminal of each TFT is connected with a pixel electrode (not shown).made of transparent conductive materials.

The color filter panel 714 includes a plurality of pixels for at least the primary colors, such as red, green, and blue colors. The color filter panel 714 further includes a common electrode that may be made of transparent conductive materials.

The operation of the LC panel is described below.

When a driving voltage is applied to a gate terminal of a TFT, the TFT of the LC panel 710 turns on and an electric field is generated between a pixel electrode and a common electrode. The orientations of LC molecules of the LC layer 716 changes according to the electric field, which determines the transmittance of light from the FFL 100 that passes through the LC layer 716 to obtain a desired image.

The fixing member 800 surrounds edge portions of the LC panel 710 and is combined with the container 300 to attach the LC panel 710 with the backlight assembly 1000. The fixing member 800 protects the LC panel 710 damage caused by external impacts, and prevents a partial deviation between the LC panel 710 and the backlight assembly 1000.

According to the present invention, light emits from sides of the first substrate having projections and sides of the second substrate with the embossed surface or the projections, therefore the dark portion decreases and the luminance distribution of light becomes substantially uniform. Further, the backlight assembly became thinner.

It will be apparent to those skilled in the art that various modifications and variation can be made in the present invention without departing from the spirit or scope of the invention. Thus, it is intended that the present invention cover the modifications and variations is of this invention provided they come within the scope of the appended claims and their equivalents.

What is claimed is:

1. A flat fluorescent lamp, comprising:
a body comprising a first substrate;
a second substrate opposite to the first substrate and comprising a light emitter and a space divider; and
a discharge space between the first substrate and the second substrate,
wherein the light emitter has an embossed surface.

2. The flat fluorescent lamp of claim 1, wherein the first substrate has a projection.

3. The flat fluorescent lamp of claim 2, wherein the projection is provided on a portion of the first substrate corresponding to the light emitter.

4. The flat fluorescent lamp of claim 1, further comprising:
a reflective layer provided in the body and reflecting light generated in the discharge space; and
a fluorescent layer provided in the body and generating visible rays.

5. The flat fluorescent lamp of claim 4, further comprising:
a first electrode and a second electrode provided in the body and spaced apart from each other.

6. The flat fluorescent lamp of claim 5, wherein the first electrode and the second electrode are provided on an external surface of opposite ends of the second substrate, respectively.

7. A flat fluorescent lamp, comprising:
a body comprising a first substrate;
a second substrate positioned opposite to the first substrate and comprising a light emitter and a space divider; and
a discharge space between the first substrate and the second substrate,
wherein the first substrate has a projection.

8. The flat fluorescent lamp of claim 7, wherein the projection is provided on a portion of the first substrate corresponding to light emitter.

9. The flat fluorescent lamp of claim 7, further comprising:
a reflective layer provided in the body and reflecting light generated in the discharge spaces;
a fluorescent layer provided in the body and generating visible rays; and
a first electrode and a second electrode provided in the body.

10. A backlight assembly, comprising:
the flat fluorescent lamp of claim 1;
a diffusing plate spaced from the flat fluorescent lamp by a predetermined distance;
a container containing the flat fluorescent lamp and the diffusing plate; and
an inverter provided under the container and applying a discharge voltage to the electrodes to drive the flat fluorescent lamp.

11. The backlight assembly of claim 10, wherein the first substrate has a projection.

12. The backlight assembly of claim 11, wherein the projection is provided on a portion of the second substrate corresponding to the light emitter.

13. A backlight assembly, comprising:
the flat fluorescent lamp of claim 7;
a diffusing plate spaced from the flat fluorescent lamp by a predetermined distance;
a container containing the flat fluorescent lamp and the diffusing plate; and
an inverter disposed under the container and applying a discharge voltage to the electrodes to drive the flat fluorescent lamp.

14. The backlight assembly of claim 13, wherein the projection is provided on a portion of the second substrate corresponding to the light emitter.

15. A liquid crystal display, comprising:
the backlight assembly of claim 10;
a liquid crystal panel displaying images using light emitted from the flat fluorescent lamp and passing through the diffusing plate; and
a fixing member fixing the liquid crystal with the container, the fixing member being connected panel with the container.

16. The liquid crystal display of claim 15, wherein the first substrate has a projection.

17. The liquid crystal display of claim 16, wherein the projection is formed on a portion of the second substrate corresponding to the emitter.

18. A liquid crystal display, comprising:
the backlight assembly of claim 13;
a liquid crystal panel displaying images using light emitted from the flat fluorescent lamp and passing through the diffusing plate; and
a fixing member fixing the liquid crystal with the container, the fixing member being panel combined with the container.

19. The liquid crystal display of claim 18, wherein the projection is formed on a portion of the first substrate corresponding to the light emitter.
